(19) United States
(12) Patent Application Publication
(10) Pub. No.: US 2019/0098170 A1
(43) Pub. Date: Mar. 28, 2019

(54) SYSTEM AND METHOD FOR CONVERTING A MULTI-OBJECT SCAN INTO DISCRETE DOCUMENTS

(71) Applicants: Kabushiki Kaisha Toshiba, Minato-ku (JP); Toshiba TEC Kabushiki Kaisha, Shinagawa-ku (JP)

(72) Inventors: Marianne KODIMER, Huntington Beach, CA (US); Devon STANLEY, Irvine, CA (US); Hsiao-Hsuan YU, Irvine, CA (US); Jeffery WONG, Aliso Viejo, CA (US)

(21) Appl. No.: 15/714,268

(22) Filed: Sep. 25, 2017

(51) Int. Cl. H04N 1/38; H04N 1/00; H04N 1/387

(52) U.S. Cl. CPC H04N 1/38; H04N 1/00816; H04N 1/3876; G06T 3/4015; H04N 1/00453; H04N 1/00448; H04N 2201/0094

(57) ABSTRACT

A system and method for discretizing individual documents from a concurrently scanned group of documents includes an intelligent controller having a processor and memory and a scanner that generates an scanned electronic image from a group of documents disposed on a platen of the scanner with spaces between the individual documents. The controller determines the edges of the each of the individual document areas within the scanned electronic image and generates a unique image file for each of the determined individual document areas. The controller previews each of the unique image files on a display of an associated user interface, and the user interface receives user input for performing desired operations of the previewed image files.

### TECHNICAL FIELD

This application relates generally to separating a multi-object scan into discrete documents. This application is more particularly directed to generating separate documents from a single scan of multiple objects on a multifunction peripheral.

### BACKGROUND

Document processing devices include printers, copiers, scanners and e-mail gateways. More recently, devices employing two or more of these functions are found in office environments. These devices are referred to as multifunction peripherals (MFPs) or multifunction devices (MFDs). As used herein, MFPs are understood to comprise printers, alone or in combination with other of the afore-noted functions. It is further understood that any suitable document processing device can be used.

Users can place multiple paper items simultaneously on a platen of a MFP to scan and capture images of all of the items in a single scan. It is often more efficient for the user to put all of the items on the platen for single scan than to scan multiple items individually. However, this results in multiple items being included in the same document. If the user desires to separate the items into separate documents, the user typically has to open the scanned document on their personal computer and cut-and-paste parts of the document into separate documents, for example using a separate software application which may incur additional setup costs. It is therefore labor intensive and time consuming to either scan multiple items separately, or to separate a scanned document into multiple individual documents using a different platform.

### SUMMARY

In accordance with an example embodiment of the subject application, a system and method for discretizing individual documents from a concurrently scanned group of documents includes an intelligent controller having a processor and memory and a scanner that generates an scanned electronic image from a group of documents disposed on a platen of the scanner with spaces between the individual documents. The controller determines the edges of the each of the individual document areas within the scanned electronic image and generates a unique image file for each of the determined individual document areas. The controller previews each of the unique image files on a display of an associated user interface. The user interface receives user input for performing desired operations of the previewed image files, such as joining two images files into a single document, storing an image file as a document on a network server, emailing an image file as a document, printing an image file, or deleting an image file from memory.

### BRIEF DESCRIPTION OF THE DRAWINGS

Various embodiments will become better understood with regard to the following description, appended claims and accompanying drawings wherein:

FIG. 1 is an example embodiment of a document discretizing system;

FIG. 2 is an example embodiment of a networked digital device;

FIG. 3 is an example embodiment of a platen disposed above a scanner bar;

FIG. 4 is an example embodiment of detected document areas within a scanned image;

FIG. 5 is an example embodiment of a scanned image of multiple documents;

FIG. 6 is an example embodiment of a user interface for previewing discretized document images from a scanned image; and

FIG. 7 is a flowchart of an example embodiment of operations for generating discrete documents from a single multi-document scan.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

When papers accumulate, it is advantageous to scan them into electronic form. Image files for scanned papers can be archived, such as by saving them to a server. They can also be sent to a network destination, such as by attaching them to an e-mail for electronic delivery. It is possible to sequentially scan each of a plurality of papers. This may be done by aligning a paper on an MFP platen, closing a device cover, and selecting a scan option on the MFP. Because papers can be flimsy, the papers may shift on a platen or even fall off entirely when a cover is lowered for copying. Multiple papers may be copied at once, but it can be problematic aligning multiple papers on a platen for simultaneous copying. In an example embodiment, a MFP scanner platen may have a size of approximately 12×18 inches, permitting the simultaneous scanning of multiple documents of different sizes.

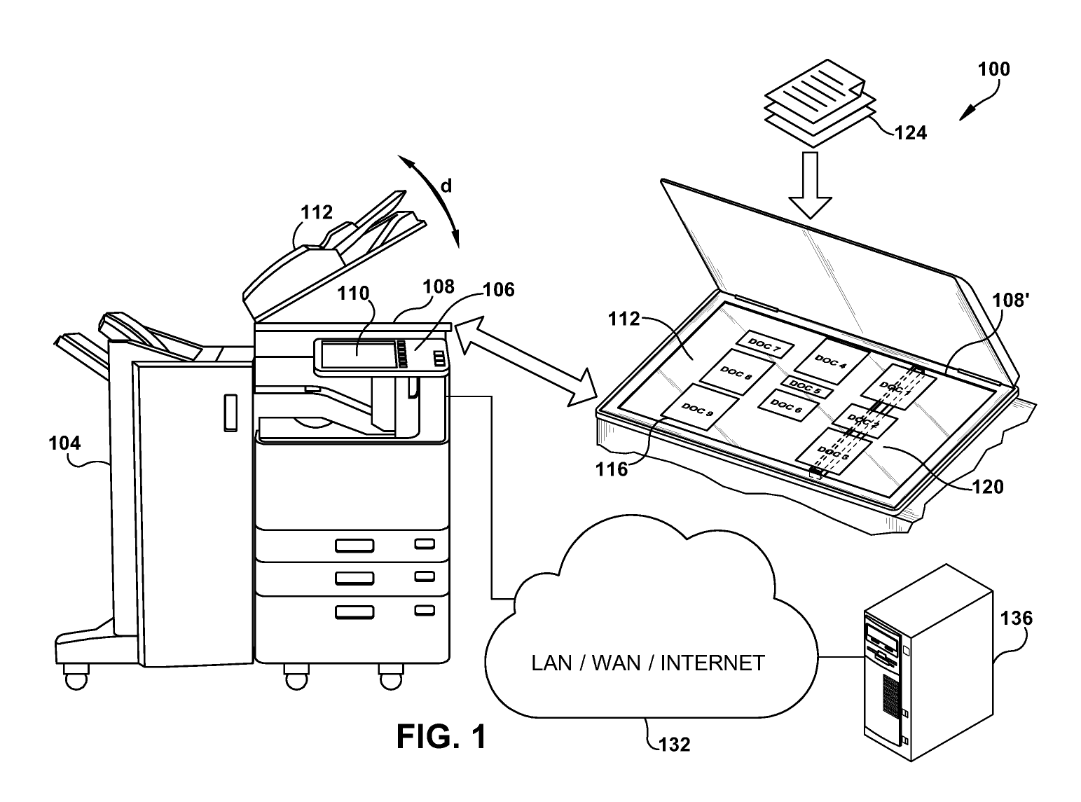

In accordance with the forgoing application, FIG. 1 illustrates an example embodiment of a discretized page scanning system 100 that includes MFP 104. MFP 104 suitably includes a user interface 106 having a display screen 110 configured to preview captured images of the documents. MFP 104 includes a scanner configured to scan documents disposed on platen 108. Scanner cover 112, illustrated as part of an automated document feeder (ADF), is moveable relative to platen 108 to cover documents placed on the platen during a scan operation. If a scan is made without a cover, areas not covered by a document are subject to extreme overexposure and will appear black on the resultant scan. Printouts of such scans require large amounts of extraneous toner. In the example embodiment, cover 112 is pivotable relative to platen 108 in a direction “d.” A perspective view of platen 108 is found at 108′. Platen 108′ illustrates placement of individual documents 112, 116 and 120 from a group of documents 124. Documents 124 are suitably placed, printed portion face down, on platen 108′. Multiple documents 124 can be positioned in any way to use as much of a surface of platen 108′ as possible. Each document 124 need only be positioned so that there is spacing between it and other document 124. Details of the resultant scanning operation are detailed further below.

MFP 104 is suitably connected to one or more digital devices by a network 132, suitably comprised of a local area network (LAN) or a wide area network (WAN) which may comprise the Internet, or any suitable combination thereof. Network 132 suitably provides for data communication between MFP 104 and one or more devices, such as server 136.

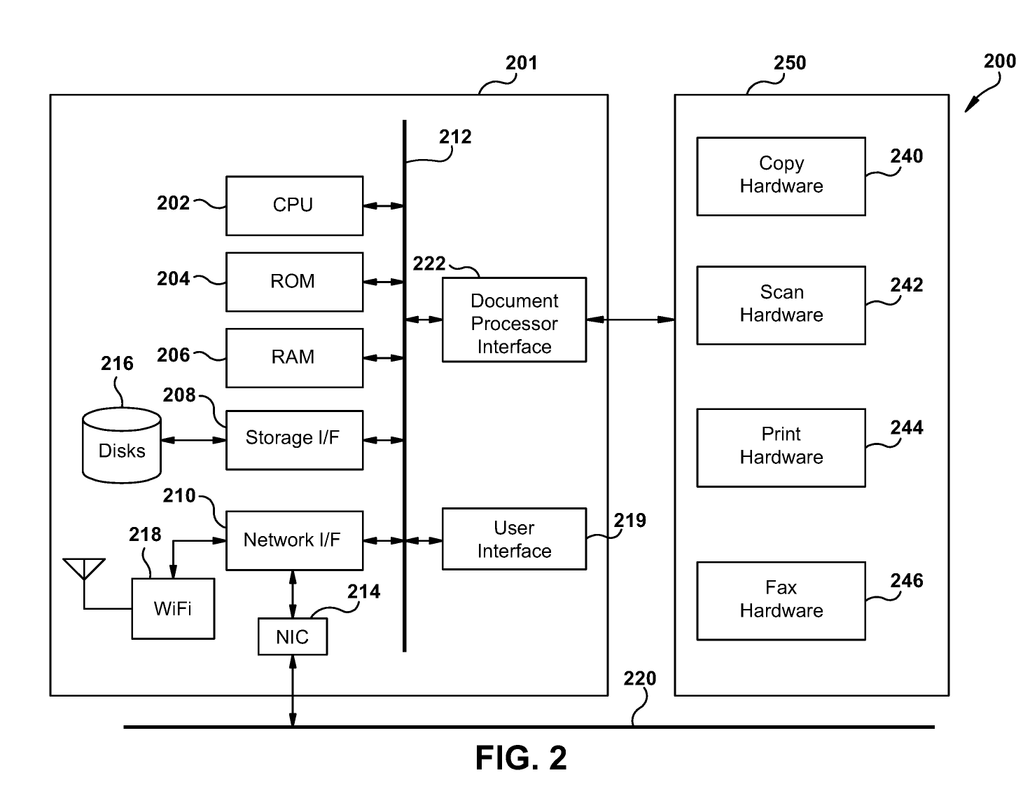

Turning now to FIG. 2 illustrated is an example embodiment of a networked digital device comprised of document rendering system 200 suitably comprised within an MFP, such as with MFP 104 of FIG. 1. Included in controller 201 are one or more processors, such as that illustrated by processor 202. Each processor is suitably associated with non-volatile memory, such as ROM 204, and random access memory (RAM) 206, via a data bus 212.

Processor 202 is also in data communication with a storage interface 208 for reading or writing to a storage 216, suitably comprised of a hard disk, optical disk, solid-state disk, cloud-based storage, or any other suitable data storage as will be appreciated by one of ordinary skill in the art.

Processor 202 is also in data communication with a network interface 210 which provides an interface to a network interface controller (NIC) 214, which in turn provides a data path to any suitable wired or physical network connection 220, or to a wireless data connection via wireless network interface 218. Example wireless connections include cellular, Wi-Fi, Bluetooth, NFC, wireless universal serial bus (wireless USB), satellite, and the like. Example wired interfaces include Ethernet, USB, IEEE 1394 (FireWire), Lightning, telephone line, or the like. Processor 202 is also in data communication with BLUETOOTH Interface 221 which may be programmed to function as a device beacon as noted above.

Processor 202 can also be in data communication with any suitable user input/output (I/O) interface 219 which provides data communication with user peripherals, such as displays, keyboards, mice, track balls, touch screens, or the like.

Also in data communication with data bus 212 is a document processor interface 222 suitable for data communication with MFP functional units 250. In the illustrated example, these units include copy hardware 240, scan hardware 242, print hardware 244 and fax hardware 246 which together comprise MFP functional hardware 250.

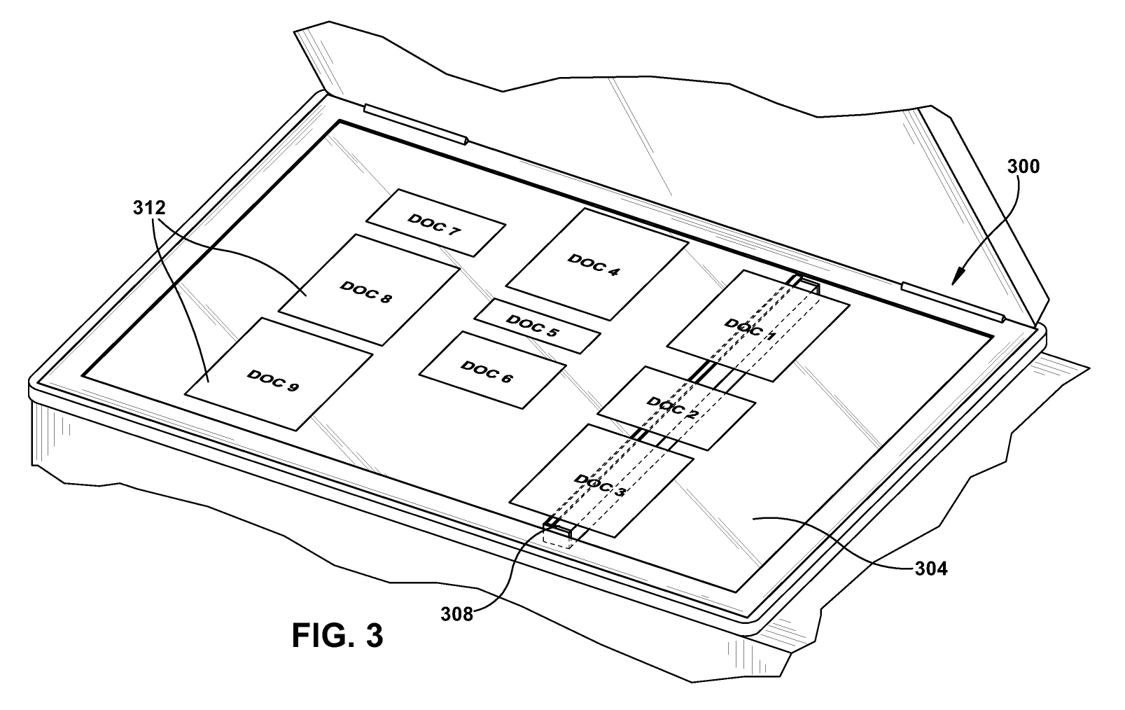

Referring next to FIG. 3, illustrated is a scanner 300 having a platen 304 that is disposed above a scanner bar 308 that traverses the platen 304 during a scan. A plurality of documents 312 are positioned on a surface of platen 304. It will be noted that platen 304 can be uncovered during the illustrated scan. Example documents can include business cards, printed pages, pictures, notes, receipts, book pages, and so forth.

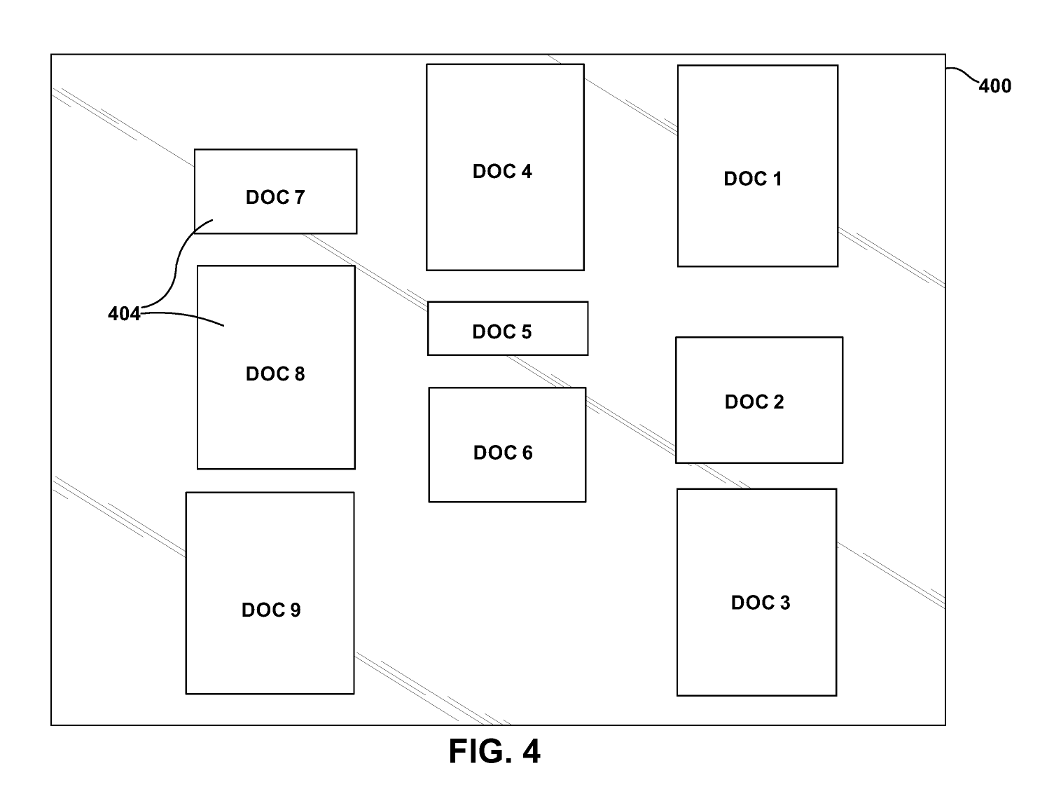

FIG. 4 illustrates detected document areas 400 in a scan of the platen. The scan is initially scanned into memory of the MFP as a single scanned image. Once the scan 400 is stored in memory, the MFP controller performs graphic processing of the scan to determine the boundaries of each of the individual documents areas 404

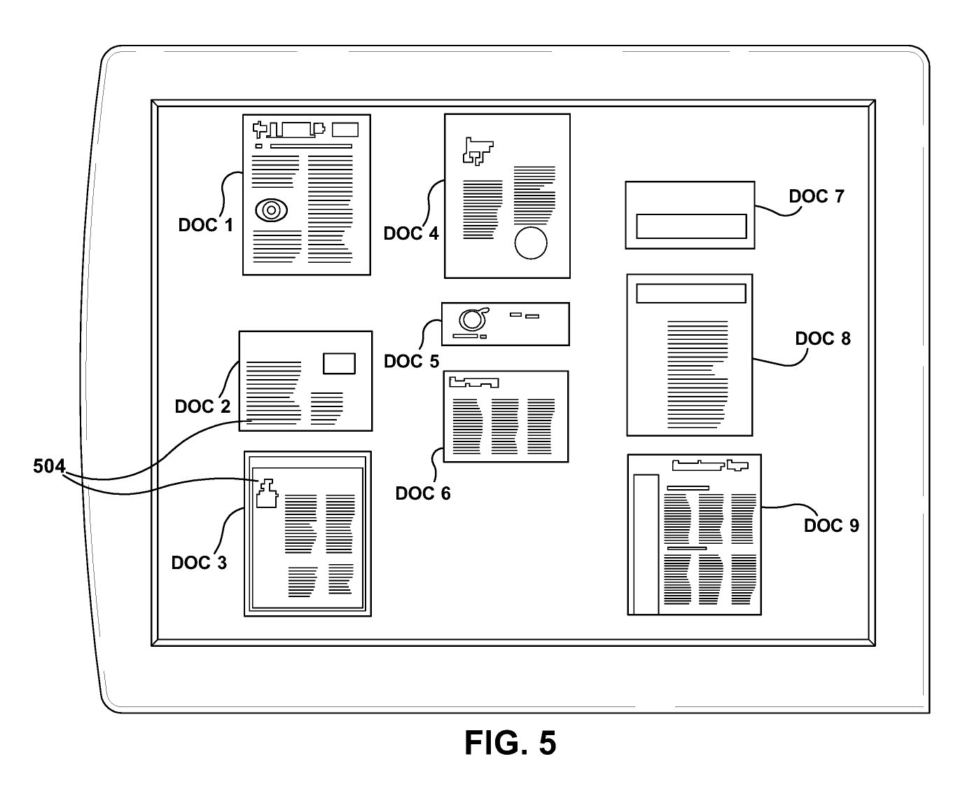

FIG. 5 illustrates a set of discretized documents 500 based on the detected document areas 400 of FIG. 4. It will be noted that if the platen was uncovered during the illustrated scan, then areas between the individual documents 504 will be overexposed and appear black, rather than white as illustrated. Each individual document 504 is stored in memory as a separate document.

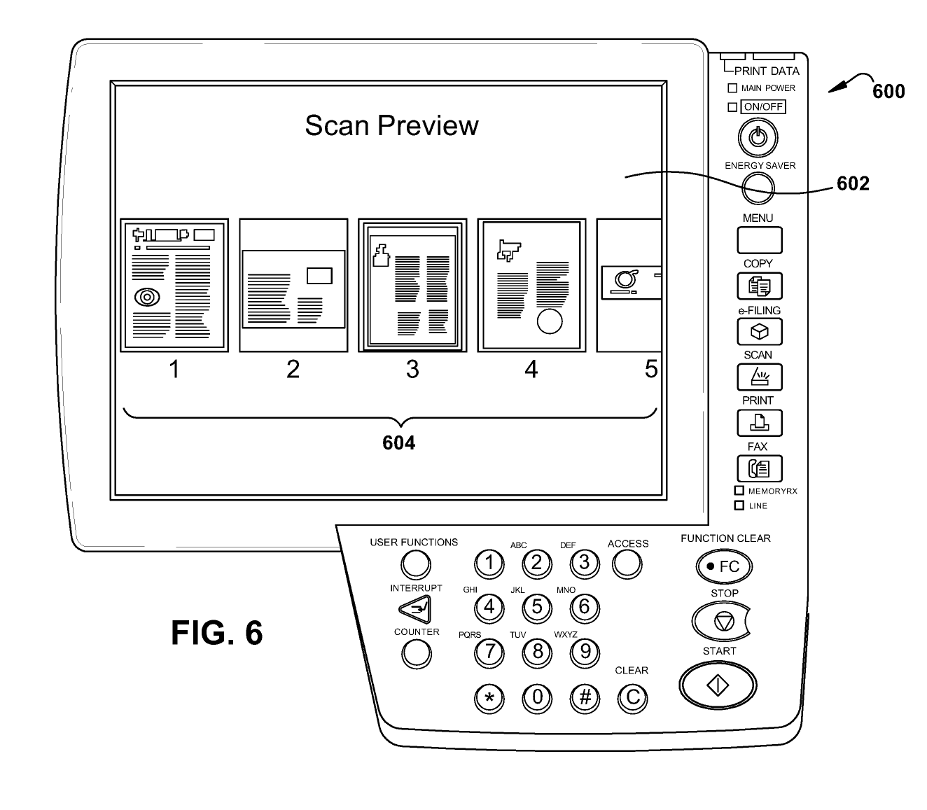

FIG. 6 illustrates a front panel interface 600 having a display screen 602 that previews each of the individually discretized documents 604. Through the front panel interface 600, the user can save each of the individually discretized documents 604 to a desired destination or multiple different destinations. For example, the display screen 602 can be a touchscreen that allows the user, through associated software, to manipulate the individually discretized documents 604 and perform desired functions. For example, the user can print one individually discretized document 604, email another individually discretized document 604 as an attachment, and store another individually discretized document 604 on a network server. In another example, the user can combine two or more individually discretized documents 604 into a single document. In another example, the user can break one individually discretized document 604 into two documents. In another example, the user can discard one or more of the individually discretized documents 604. Other operations can be performed as would be understood in the art. The user can also select a suitable operation for the originally scanned image, for example by archiving the scan on a suitable server. Once the user has performed the desired operations, the user can exit from the preview screen which prompts the MFP controller to discard the scan from memory.

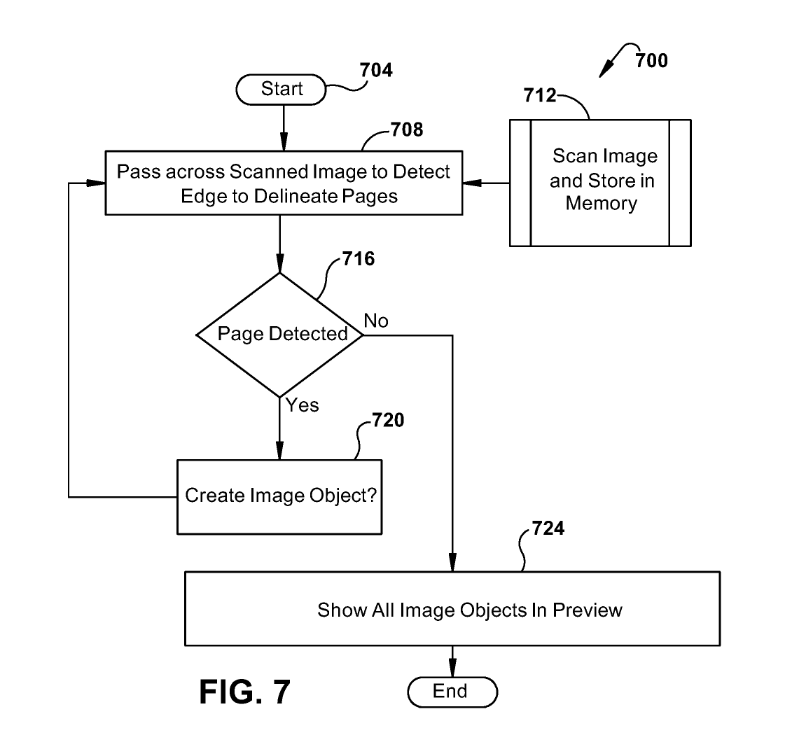

FIG. 7 is a flowchart 700 of an example embodiment of a discretized page scanning system such as that detailed above. The process commences at block 704 and proceeds to block 708. The MFP executes graphics software at block 708 that analyzes an image scanned by the MFP of multiple documents, or pages, that were placed on the platen and scanned by the MFP into a single image file in block 712. The graphics software analyzes the scanned image to detect the edges of individual pages in the scanned image. If an individual page is detected at block 716, then an separate image object corresponding to that individual page is created at block 720 and the process returns to block 708 to continue analyzing the scanned image for additional pages. Once no more individual pages are detected at block 716, each of the separate image objects are displayed at block 724 on a preview window of the display screen of the MFP and the user can perform desired operations on selected image objects as described above. Once the user has performed all desired operations on the individual image object and exits the preview screen, processing terminates at block 728

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

1. A system comprising:
a platen configured to receive a plurality of document pages on a surface thereof;
a moveable cover configured to selectively cover and uncover the platen;
a scanner configured to generate a scanned image from the document pages disposed on the platen;
a user interface; and
an intelligent controller including a processor and a memory,
the controller configured to store the scanned image in the memory, the scanned image including images of each of the plurality of document pages separated by spaces between the document pages,
the controller further configured to determine edges of each of the images in the scanned image relative to the spaces between, and
the controller further configured to generate a unique image file corresponding to an image of a document page,
the controller further configured to store each of the unique image files as a separate image document;
the controller further configured to process at least one of the unique image files in accordance with instructions received from an associated user via the user interface.

2. (canceled)

3. The system of claim 1 further comprising:
a user interface having a display,
wherein the controller is further configured to present a preview of each of the image files on the display.

4. The system of claim 3 wherein the user interface is configured to receive a user input to perform an operation on one or more of the image files.

5. The system of claim 4 wherein the operation is selected from the group consisting of joining two images files into a single document, storing an image file as a document on a network server, emailing an image file as a document, printing an image file, and deleting an image file from memory.

6. The system of claim 1 wherein the controller is further configured to enable the scanner when the platen is in an uncovered position.

7. The system of claim 1 wherein each of the plurality of document pages is selected from the group consisting of a business card, a printed receipt, a printed page, a book page, a note, and a picture.

8. A method comprising:
opening a cover to expose a platen of a scanner;
placing a plurality of individual documents on a surface of the platen;
scanning the plurality of the individual documents on the platen into a single scanned image;
determining, from the single scanned image, edges of each of the plurality of individual documents within the single scanned image;
generating, for each individual document within the single scanned image, a unique image file corresponding to an image of the individual document;
storing each unique image file as a separate document; and
processing at least one of the unique image files in accordance with instructions received from an associated user via the user interface.

9. (canceled)

10. The method of claim 8 further comprising:
displaying, on an associated user interface, a preview of each of the unique image files.

11. The method of claim 10 further comprising:
receiving, via the associated user interface, a user input to perform an operation on one or more of the image files; and
performing the operation associated with the user input on the one or more image files.

12. The method of claim 11 wherein the operation is selected from the group consisting of joining two images files into a single document, storing an image file as a document on a network server, emailing an image file as a document, printing an image file, and deleting an image file from memory.

13. The method of claim 9 wherein the scanning is performed with the platen in an uncovered position.

14. The method of claim 10 wherein each of the plurality of individual documents is selected from the group consisting of a business card, a printed receipt, a printed page, a book page, a note, and a picture.

15. A system comprising:
a user interface,
a scanner including a platen configured to receive multiple, separated document pages on a surface thereof,
the scanner configured to scan the document pages through the platen to generate a single scanned image; and
a processor configured to detect individual document areas within the single scanned image based at least in part on spaces between the separated document pages,
the processor further configured to generate a separate image file for each of the detected individual document areas,
the processor further configured to process at least one of the unique image files in accordance with instructions received from an associated user via the user interface.

16. The system of claim 15 wherein the scanner is further configured to scan the document pages while the platen is uncovered.

17. The system of claim 15 further comprising:
a user interface having a display,
wherein the processor is further configured to present a preview of each of the separate image files on the display.

18. The system of claim 17 wherein the user interface is configured to receive a user input to perform an operation on one or more of the previewed image files.

19. The system of claim 18 wherein the operation is selected from the group consisting of joining two images files into a single document, storing an image file as a document on a network server, emailing an image file as a document, printing an image file, and deleting an image file from memory.

20. The system of claim 15 wherein the processor is further configured to detect individual areas with the single scanned image based at least in part on edge detection of the separated document pages within the single scanned image.
